(19) United States
(12) Patent Application Publication
(10) Pub. No.: US 2026/0243184 A1
(43) Pub. Date: Aug. 20, 2026

(54) INTEGRATED PROCESS FOR REMOVING CARBON DIOXIDE FROM A SHIP OR OFFSHORE FLOATING VESSEL USING A ROTATING PACKED DEVICE

(71) Applicant: CHEVRON U.S.A. INC., San Ramon, CA (US)

(72) Inventor: Marcus V. DUTRA E MELLO, Moraga, CA (US)

(21) Appl. No.: 18/872,238

(22) PCT Filed: Jun. 6, 2023
(86) PCT No.: PCT/US2023/068014

§ 371 Date: Dec. 5, 2024

Related U.S. Application Data
(60) Provisional application No. 63/349,153, filed on Jun. 6, 2022.

(51) Int. Cl. F01N 3/037; B63H 21/32

(52) U.S. Cl. CPC F01N 3/037; B63H 21/32

(57) ABSTRACT

A method for scrubbing flue gas, comprising: providing a rotating packed bed device onboard a ship or marine vessel generating flue gas; co-feeding an absorbent with the flue gas into the rotating packed bed to remove carbon dioxide.

### CROSS-REFERENCE TO RELATED APPLICATION

This application is a national phase application of PCT/US2023/068014 filed Jun. 6, 2023, which claims the benefit of U.S. Provisional Patent Application No. 63/349,153, filed Jun. 6, 2022, which is incorporated by reference herein in its entirety.

### FIELD OF THE INVENTION

This invention relates to improved methods and systems for removing carbon dioxide from flue gas onboard of ships or other offshore floating vessels using rotating packed bed device.

### BACKGROUND OF THE INVENTION

The shipping sector is one of the most difficult to decarbonize because abatement treatments need to be installed on ships where motion, limited footprint, weight, and other constraints may pose challenges. The available conventional technologies for abating CO2 in an onshore environment, such as the packed tower, are not ideal solutions for the offshore environment for being too bulk. Due to its large size, they may need to be oversized and its structure reinforced to accommodate for the motion forces that are encountered in the marine environment.

The Rotating Packed Bed technology (RPB) offers advantages for the marine environment such as low height, weight and footprint, lower absorbing liquid inventory and lower cost for carbon dioxide capture. In addition, the RPB technology has operability advantages as it relies on centrifugal forces to enhance the mass transfer process and therefore it is insensitive to motion and orientation, making it suitable for the marine application. The RPB turn-down ratio is 10%, making it suitable for different engine loads.

Marine environments are unstable and due to wave action, wind, and other forces that can cause motion, conventional scrubbers are subject to blow-by and unstable performance. Due to the unstable and often unpredictable motion on ships it can be difficult to maintain effective contact between flue gases and either liquids or solids that are used to scrub flue gases. As a result, conventional flue gas scrubbing systems need to be overdesigned, which increases one or more of cost, weight, height, and footprint.

Previous systems for flue gas scrubbing, such as those using fluidized beds or packed bed spray scrubbers, have been very large and heavy. Previous systems would also be difficult to retrofit onto existing ships.

Improved methods and systems are needed for removing contaminants comprising carbon dioxide from flue gas onboard of ships. Improved systems are needed that remove flue gas contaminants more efficiently.

Previous attempts at removing contaminants from flue gas have targeted SOx removal on ships is an open system utilizing seawater that is discharged back into the ocean. Amines or other commercially produced chemical solvents are harmful and can not be discharged at sea. Further attempts at removing CO2 from feed gas have targeted natural gas and the like that are available at much higher pressures than flue gas. A system or process to capture CO2 that avoids discharge of harmful chemical solvents into the ocean and addresses the ambient pressure of flue gas is needed and described herein.

### SUMMARY OF THE INVENTION

An embodiment of the invention is a closed loop process for removing CO2 from a flue gas comprising a Venturi Quencher to treat the hot flue gas from a ship and cool it down.

Another embodiment is feeding the cooled flue gas into one or more rotating packed bed (RPB) devices and contact with a scrubbing fluid that is selective for CO2 capture such as conventional amines (MEA, DEA and MDEA), advanced amines comprising activated MDEA, combination of piperazine and MDEA, ionic liquids or switchable polarity fluids (SPS).

Another embodiment is an integrated system for the scrubbing fluid containing two tanks, one for holding the fresh liquid and another to collect the spent fluid that has reacted with CO2.

A further embodiment is one or more RPB devices located in a hull or the funnel of the marine ship, comprising of a rotating shaft and a porous media and configured to mix the flue gas with the CO2 capture liquid in an outwardly direction at a sufficient gas/liquid ratio to reduce the CO2 concentration in the flue gas to the desired level. The outwardly flue gas/liquid feeding of the RPB may be co current and will allow for a pressure increase of up to 50 kPa from the interior region to the exterior region of the RPB and to overcome the pressure limitation of the flue gas.

Another embodiment of this invention is to add another RPB to regenerate the spent fluid onboard and store the desorbed CO2 in tanks onboard. Another option is to regenerate the spent fluid at an onshore facility during a port stay.

### BRIEF DESCRIPTION OF THE DRAWINGS

FIG. 1 depicts an embodiment of the invention illustrating energy recovered from liquid expansion and pressure reduction being used to drive a rotating packed bed absorber.

### DETAILED DESCRIPTION OF THE INVENTION

Herein is described a process and closed system for removing CO2 from flue gas generated from a ship or marine vessel without the use of seawater. The process and system employ CO2 capture on a ship by one or more RPB devices in conjunction with chemical reaction between CO2 and an amine or advanced solvents, such as ionic liquids or switchable polarity solvents (SPS).

A “ship” is a large navigational watercraft that travels the world's oceans and other sufficiently deep waterways via one or more engines that emit flue gas or CO2 laden gas, carrying passengers or goods, or in support of specialized missions, such as defense, research and fishing. A “marine ship” is a ship operated in an ocean or in seawater.

“Flue gas” is a gas exiting to the atmosphere via a flue, which is a pipe or channel for conveying exhaust gases from a fireplace, an engine, an oven, a furnace, a boiler or a steam generator. The flue gas, for example, can refer to the combustion exhaust gas produced by an engine. “Total suspended solids” (TSS) is the dry-weight of particles trapped by a filter. It is a water quality parameter used for example to assess the quality of wastewater after treatment in a wastewater treatment plant. TSS is listed as a conventional pollutant in the U.S. Clean Water Act. “Heavy fuel oil” (HFO) describes fuels used to generate motion and/or fuels to generate heat that have a particularly high viscosity and density. Heavy fuel oil can be defined either by a density of greater than 900 kg/m3 at 15° C. or a kinematic viscosity of more than 180 mm2/s at 50° C. Heavy fuel oils can have large percentages of heavy molecules such as long-chain hydrocarbons and aromatics with long-branched side chains, and they may be black in color.

“Centrifugal force” is an inertial force directed away from the axis of rotation that appears to act on all objects when viewed in a rotating frame of reference. The radial force generated by a spinning rotor is expressed relative to the earth's gravitational force and therefore is known as the relative centrifugal force (RCF) or the “g force.” The g force acting on particles is exponential to the speed of rotation (defined as revolutions per minute (RPM)). The function between these two parameters follows this equation: RCF=1.2 r (RPM/1000) (RPM/1000), where r is in millimeters.

“Turndown ratio” refers to the width of the operational range of a device and is defined as the ratio of the maximum operating capacity to minimum operating capacity. For example, a device with a maximum output of 10 units and a minimum output of 2 units has a turndown ratio of 5.

“Antiscalant agents” are a family of chemicals designed to inhibit the formation and precipitation of crystallized mineral salts that form scale.

Sufficient centrifugal force in the context of this invention can be a RCF that is sufficient to promote good gas-liquid contact and prevent a blow-by of the flue gas 15 during operation of a rotating packed bed device 4. In one embodiment, the RCF can be greater than 1, such as from greater than 4 up to 10,000. Blow-by can be caused by motion on the ship or on the offshore floating vessel, and can be very difficult to prevent using conventional flue gas 15 scrubbers.

Removal of CO2 from flue gas is initiated by feeding the flue gas to a Venturi Quencher to treat the hot flue gas from a ship and cool it down and subsequently feeding the cooled flue gas into a RPB device and contact with a scrubbing fluid or also referred to herein as liquid absorbent. The scrubbing fluid comprises CO2 capture fluids known to one of skill in the art, preferably selected from, conventional amines (MEA, DEA and MDEA), advanced amines (activated MDEA, combination of piperazine and MDEA), aqueous potassium carbonate either by itself or promoted with piperazine, ionic liquids or switchable polarity fluids (SPS). The process as described herein can remove up to 92% CO2 from flue gas and up to 100% when multiple RPBs are implemented.

Table 1 below shows examples of good CO2 removal at various flow rates of CO2 and methyl ethanolamine (MEA).

TABLE 1

| | | | | | |
|---|---|---|---|---|---|
| N2 Feed | CO2 Feed | Total Gas | MEA Flowrate | CO2 Concentration | CO2 Removed |

| | | | | Feed | Product | |
|---|---|---|---|---|---|---|
| (SCFH) | (SCFH) | (SCFH) | (GPM) | (vol %) | (vol %) | % |
| 4000 | 210 | 4210 | 0.7 | 5 | 1.1 | 79 |
| 4000 | 210 | 4210 | 0.8 | 5 | 0.7 | 87 |

Increase CO2 vol % in feed (7.5 vol %)

| | | | | | | |
|---|---|---|---|---|---|---|
| 4000 | 325 | 4325 | 1.1 | 7.5 | 1.2 | 80 |
| 4000 | 325 | 4325 | 1.6 | 7.5 | 0.7 | 91 |

Increase CO2 vol % in feed (10 vol %)

| | | | | | | |
|---|---|---|---|---|---|---|
| 4000 | 446 | 4446 | 1.5 | 10 | 1.6 | 85 |
| 4000 | 446 | 4446 | 1.8 | 10 | 1.2 | 89 |

An embodiment of the invention is an integrated system for the scrubbing fluid that includes two tanks, one for holding the fresh liquid and another to collect the spent fluid that has reacted with the CO2.

A further embodiment is regeneration of the spent fluid via feed to one or more RPBs and store the desorbed CO2 in tanks onboard a ship or vessel or regenerate the spent fluid at an onshore facility during a port stay Regeneration consists of applying temperatures above 212 OF to the spent fluid to release the CO2 from. The scrubbing fluid is CO2 free or partially free and is able to capture the CO2 again in an absorption cycle. Such regeneration may be by any convenient method and may use a regenerator for regenerating the impurity-rich liquid solution. The regenerator is optionally and operably linked to, for example, the flash drum and rotating packed bed absorber. In this manner the impurity-rich liquid may be delivered to a second (or more) rotating packed bed regenerator to be used for regeneration. The specific equipment of the regenerator may vary depending upon the specific process, other equipment, and available space. For example, the regenerator may comprise, for example, a heater, such as a reboiler and a condenser, one or more additional rotating packed bed regenerators, with one or more rotatable packing rings, or even some combination thereof. If desired, the heating or reboiler unit may be external to the rotating packed bed chamber, or partially or fully integrated, i.e., inside the rotating packed bed chamber. In some embodiments, the regenerator may comprise a packed tower.

A further embodiment is an RPB device located in a hull or the funnel of the marine ship, comprising of a rotating shaft and a porous media and configured to mix the flue gas with the CO2 capture liquid in an outwardly direction at a sufficient gas/liquid ratio to reduce the CO2 concentration in the flue gas to the desired level. The co-current, outwardly flue gas/liquid feeding of the RPB will allow for a pressure increase of up to 50 kPa from the interior region to the exterior region of the RPB and to overcome the pressure limitation of the flue gas. Additional pressure increases to overcome the pressure limitation of flue gas, such as pressure increases greater than 50 kPa may be effected by increasing the rotational speed of the RPB. A counter current mode is also an embodiment of the invention. Both the co-current and the counter current mode are described in 11,491,441, herein incorporated by reference, wherein the fluid utilized is not seawater.

Sufficient centrifugal force in the context of this invention can be a RCF that is sufficient to promote good gas-liquid contact and prevent a blow-by of the flue gas 15 during operation of a rotating packed bed device 4. In one embodiment, the RCF can be greater than 1, such as from greater than 4 up to 10,000. Blow-by can be caused by motion on the ship or on the offshore floating vessel and can be very difficult to prevent using conventional flue gas 15 scrubbers. In one embodiment, the sufficient centrifugal force provides a liquid holdup in the rotating packed bed device 4 that is less than 1 wt %, such as from 0.01 to 0.50 wt %. The low liquid holdup reduces weight and provides efficient use of a porous material in the rotating packed bed device 4. For example, in one embodiment, the rotating packed bed device 4 comprises one or more rotatable packing rings 4A of a porous material that operate under a sufficient centrifugal force to provide a liquid holdup in the rotating packed bed device 4 from 0.01 to 0.50 wt %.

In one embodiment, the rotating packed bed device 4 comprises a porous material with a high surface area per unit volume, such as greater than 150 m2/m3, or from about 200 to about 6,000 m2/m3. In one embodiment, the rotating packed bed device 4 comprises one or more rotatable packing rings 4A comprising a porous material with a high surface area per unit volume. In one embodiment, the rotating packed bed device 4 comprises one or more rotatable packing rings 4A that comprise the porous material.

Rotating packed bed device as described in WO 2018/229589 A1, U.S. Pat. No. 11,491,441, herein incorporated by reference, can be utilized with the system and process for removal of CO2 from flue gas set forth herein.

An embodiment of the invention is an RPB device located in a hull or the funnel of the marine ship, comprising of a rotating shaft and a porous media and configured to mix the flue gas with the CO2 capture liquid in an outwardly direction at a sufficient gas/liquid ratio to reduce the CO2 concentration in the flue gas to the desired level. The co-current, outwardly flue gas/liquid feeding of the RPB will allow for a pressure increase of up to 50 kPa from the interior region to the exterior region of the RPB and to overcome the pressure limitation of the flue gas. A preferred embodiment is to co-feed the gas and liquid through the annulus portion of the RPB to overcome the pressure drop of the flue gas.

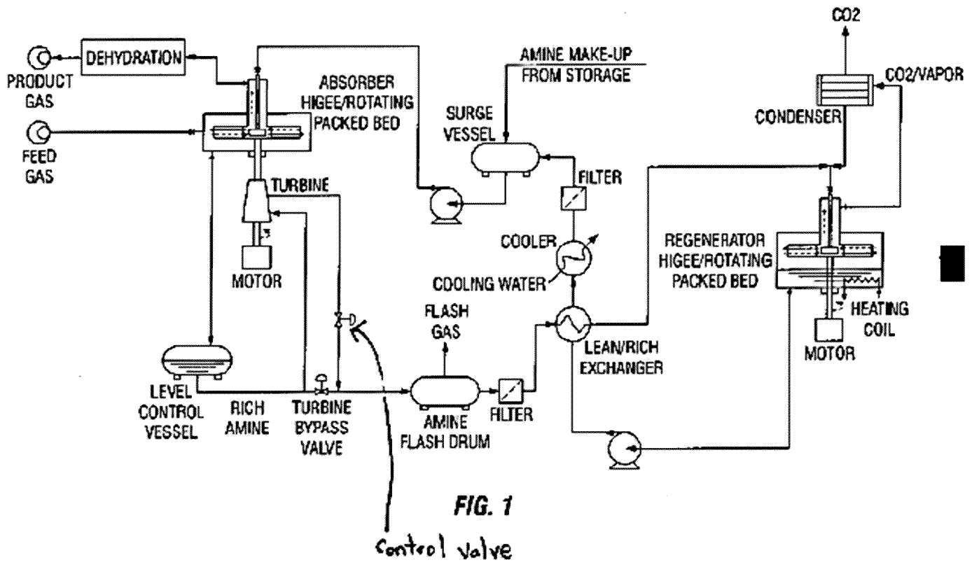

Referring to the exemplary embodiment in FIG. 1 and the description of a RPB from U.S. Pat. No. 491,441 for interior and exterior regions of an RPB, methods disclosed herein can utilize a system as shown, including a rotating packed bed device. In this embodiment, the rotating packed bed device includes one or more rotatable packing rings disposed with a housing. The one or more rotatable packing rings can generally have the shape of a thick cylindrical disk having a hollow central axial portion or space, also referred to herein as an interior region. The rotatable packing rings surrounding the interior region define the interior region. The rotatable packing rings are enclosed in a space inside the housing. This space is the exterior region in the rotating packed bed device, which is not labeled in FIG. 1. Additionally, a Venturi quencher, not labelled in FIG. 1 is configured within the system to receive hot flue gas from a ship and cool it down and subsequently feeding the cooled flue gas into a RPB device and contact with a scrubbing fluid as described herein. In one embodiment, a pressure increase forms between an interior region in the rotating packed bed device 4 and an exterior region in the rotating packed bed device. The pressure increase can be 0 kPa or greater, such as greater than 2 or 3 kPa, for example, from 0 kPa to 50 kPa. This pressure increase can function like a blower and can help push low-pressure flue gas 15 from an engine through the rotating packed bed device 4. The pressure increase can significantly reduce or prevent undesired back pressure on an engine on a ship or an offshore floating vessel. This can be highly desirable when dealing with low-pressure flue gas 15. In one embodiment, the maximum allowed back pressure that a ship engine can tolerate is 981 Pa, and the rotating packed bed device 4 is configured to prevent back pressure on the ship engine.

The high gravity created by the centrifugal force of the rotatable packing rings 4A allows the use of unique packing materials with very high surface area and fine pore diameter. The rotatable packing rings 4A can be made from wide variety of suitable materials, including for example, metal foam, plastic, composite, stainless steel, titanium, super duplex stainless steel alloy, metal or non-metal wire mesh, knitted fabrics, and porous materials including fiberglass. In one embodiment, the rotatable packing rings 4A comprise a porous material with a surface area per unit volume (specific surface) from about 200 to about 6,000 m²/m³. In one embodiment, the rotatable packing rings 4A comprise a porous material that is a metal foam, a metal mesh, a fiberglass, a polymer, or a composite thereof. In one embodiment, the porous material has an average pore size from 100 to 10,000 micrometers. In one embodiment, the porous material is a metal foam having a porosity of at least about 90% and having an average pore size from 250 to 2500 micrometers. In one embodiment, the metal foam is a RECEMAT® metallic foam (RMF). RECEMAT is a registered trademark of RECEMAT BV, based in the Netherlands. RMF is one of the commercially available metallic foams and it is an open cell polyurethane foam metallized using an electro-deposition technique which has superior control on the cell size. In one embodiment, the RMF has a nickel microstructure, a nickel-chromium (NC) microstructure or a nickel-chromium extra foam (NCX) microstructure. In one embodiment the metal foam has a thickness from 1.6 to 20 mm and pore sizes from 0.4 to 2.3 mm. In one embodiment the metal foam has a designation of NCX0610, NCX1116, NCX1723, NCX2733, or NCX4753. The typical properties of these types of metal foams are summarized in Table 2.

TABLE 2

| Designation | NCX0610 | NCX1116 | NCX1723 | NCX2733 | NCX4753 |
|---|---|---|---|---|---|
| Grade (pores/inch) | 6 . . . 10 | 11 . . . 16 | 17 . . . 23 | 27 . . . 33 | 47 . . . 53 |
| Average pore size, | 2300 | 1400 | 900 | 600 | 400 |
| micrometers | | | | | |
| Average density, | 0.5 . . . 0.9 | 0.5 . . . 0.9 | 0.5 . . . 0.9 | 0.5 . . . 0.9 | 0.5 . . . 1.3 |
| g/cm³ | | | | | |
| Porosity | 92% | 92% | 92% | 92% | 92% |
| Specific Surface, | 500 | 1000 | 1600 | 2800 | 5400 |
| m²/m³ | | | | | |
| Avg. Composition*, | | | | | |
| Wt % | | | | | |

| | |
|---|---|
| Al | — |
| C | <0.1 |
| Cr | 30-45 |
| Cu | 0.3 |
| Fe | 5 |
| Mo | <0.1 |
| Mn | <0.1 |
| Ni | 49-64 |
| P | <0.1 |

Average composition refers to the composition of the outside surface of the metal foam.

The above-described processes and systems may be advantageous for a number of independent reasons. For example, when using integrated processes and systems with rotating packed beds for absorption and/or regeneration, there is often less capital cost and a reduction of equipment weight and/or footprint (especially vertical) due to the compact nature of rotating packed beds. In addition, the processes and systems will usually bring about enhanced safety due to reduced liquid inventory, better operability due to potential foaming reduction, and often a high turn-down ratio. In addition, the substantial insensitivity to motion of rotating packed beds may be advantageous for ships and marine vessels that generate flue gas. Yet another advantage may be in transportation and installation in remote areas. Usually, due to corrosion concerns, the amine loading is limited in a conventional vessel. However, due to the more compact nature of rotating packed beds which allows for the use of more expensive materials such as alloys, richer, i.e., more concentrated, increased amine loadings may be employed which may reduce circulation rates, which in turn may reduce operating costs.

What is claimed is:

1. A method for removing carbon dioxide from a flue gas, on a ship or marine vessel generating flue gas comprising: (a) feeding CO2 containing flue gas to a Venturi Quencher to treat the hot flue gas from a ship and cool it down, (b) feeding the cooled flue gas into a rotating packed bed (RPB) device and (c) contacting with a scrubbing fluid to form a spent fluid with bound CO2.

2. The method of claim 1, wherein rotating packed bed devices comprises one or more rotatable packing rings, wherein the one or more rotatable packing rings define an interior region and an exterior region in the rotating packed bed device.

3. The method of claim 2, wherein a pressure increase from an interior region in the rotating packed bed device to an exterior region in the rotating packed bed device is from 0 kPa to 50 kPa.

4. The method of claim 3, wherein the scrubbing fluid is selected from the group consisting of conventional amines (MEA, DEA and MDEA), advanced amines (activated MDEA, combination of piperazine and MDEA), aqueous potassium carbonate, ionic liquids or switchable polarity fluids.

5. The method of claim 1, wherein the spent fluid is regenerated via feed to one or more RPBs and store the desorbed CO2 in tanks onboard a ship or vessel or regenerate the spent fluid at an onshore facility.

6. An integrated system for onboard scrubbing of a marine exhaust gas on a ship, comprising:
i) a hot exhaust gas entry that feeds the marine exhaust gas, having a temperature greater than 180° C., from an engine on the ship; and b) the rotating packed bed device, having:
iii) a stationary gas distributor, placed along an outer circumference of the rotating packed bed device, connected to a Venturi quencher, wherein the stationary gas distributor is configured to receive the cooled exhaust gas and uniformly distribute the quenched marine exhaust gas along the outer circumference of the rotating packed bed device; and
iv) a stationary liquid distributor, with multiple liquid rings, that is centrally positioned within the rotating packed bed device, wherein the multiple liquid rings are fitted with spray nozzles that spray a liquid absorbent as a co-feed with the cooled exhaust gas into the annulus of the rotating packed bed device.
